(19) United States
(12) Patent Application Publication
(10) Pub. No.: US 2021/0076581 A1
(43) Pub. Date: Mar. 18, 2021

(54) Organic Soil Based Automated Growing Enclosure

(71) Applicant: Sureleaf, LLC, Denver, CO (US)

(72) Inventor: Gary Otterman, Longmont, CO (US)

(73) Assignee: Sureleaf, LLC, Denver, CO (US)

(21) Appl. No.: 16/961,606

(22) PCT Filed: Jan. 11, 2019
(86) PCT No.: PCT/US2019/013336

§ 371 Date: Jul. 10, 2020

Related U.S. Application Data
(60) Provisional application No. 62/617,538, filed on Jan. 15, 2018.

(51) Int. Cl. A01G 27/06; A01G 9/02; A01G 22/15; A01G 7/04; A01C 1/02; C02F 1/00; C02F 1/48; B01D 29/11; B01D 24/10; B01D 36/02

(52) U.S. Cl. CPC A01G 27/06; B01D 2201/18; A01G 22/15; A01G 7/045; A01C 1/02; C02F 1/001; C02F 1/481; C02F 1/008; B01D 29/117; B01D 24/10; B01D 36/02; C02F 2301/046; C02F 2301/024; C02F 2303/04; B01D 2101/02; A01G 9/023

(57) ABSTRACT

An automated organic closed-loop grow enclosure that has rows of hydration trays that support removable (three across) grow containers for microgreens such as broccoli. Each grow container has a layer of soil. The seeds are treated with mycorrhizae and mixed with enriched top soil having a wicking agent. The grow containers are automatically watered once a day from the bottom and the capillary action of the soil lifts and holds the water in the grow container. LED Lighting is used to stimulate day and night cycles. The water is treated with magnets, turbulence and charcoal filters. The water cascades down the tiered trays using siphons. No other treatment of the water is necessary since almost no micro-organisms or organic material leak from the grow containers due to a filter barrier in the bottom of the grow container. Spectacular consistent growth rates are easily achieved.

This application is the United States National Stage of International Patent Cooperation Treaty Patent Application No. PCT/US2019/013336, filed on Jan. 11, 2019, which claims the benefit of U.S. Provisional Patent Application No. 62/617,538, filed on Jan. 15, 2018, each hereby incorporated by reference herein.

### I. TECHNICAL FIELD

The present invention relates to providing an in-house method and maintenance free enclosure having soil based growing containers connected by a closed loop water system with an integral water treatment reservoir with programmable LED lighting, programmable hydration cycles for the organic cultivation of plants. The method and enclosure disclosed is particularly suitable for successful and consistence results for the cultivation of organic microgreens with no prior knowledge or experience required by the cultivator.

### II. BACKGROUND

Growing plants indoors in vertical rows of trays is well known, see U.S. Pat. Nos. 2,971,290 and 2,917,876 incorporated herein by reference as to their watering and siphon disclosures.

Also, well-know is hydroponic cultivation which is practiced on in-home to large scale commercial application. Hydroponics is a process wherein water carries the nutrient solution for the plants. No soil is used. Successful hydroponic systems require the cultivator to have specialized skills including understanding the composition and use of nutrient solutions, the ability to monitor and adjust PH levels while keeping the hydroponic system free from salt and scale build up.

Another well known cultivation method that is done in-home and on large scale commercial applications is Aquaponics. Aquaponics balances the waste from fish in the reservoir as the nutrient solution that is cycled to the plants and returned to the reservoir. Aquaponics is yet more difficult to master for the cultivator and requires understanding the nitrification processes, algae blooms, and the balance of fish to plant ratios to be successful.

Another cultivation method that is practiced in-home and commercially is Aeroponics. The method uses a reservoir from which water carrying the nutrient solution is sprayed on the roots of plants that have been suspended in the air within an enclosure, the excess water is then returned to the reservoir. This method also requires the cultivator to understanding the use of nutrient solutions, pH levels and technical applications of high pressure pumps. Aeroponics by design is the most difficult and expensive to master.

The three cultivation methods mentioned above are all closed loop, meaning the water is cycled from the reservoir to the plants then back to the reservoir repeatedly, thus they are ideal for automation. These three methods are soilless, meaning they use no soil to grow plants. Most of these applications require chemical fertilizers and chemical-agents (additives) to create a stable nutrient solution and maintain proper PH levels for the application to work successively and are not organic. Although in recent years some of the Hydroponic and Aquaponic systems have been approved by the UDSA and have received organic certification and use products that have been approved for the “Organic Hydroponic Application”. However, it is still questionable that these organic Hydroponic-Aquaponic plants truly receive the same nutrient values as plants grown is soil.

What is needed in the art is a simple automated closed loop organic method, using soil, to grow plants in a controlled environment for in-home use that could be scaled to commercial applications. The obstacle in introducing soil or any organic material into an automated closed loop application has been the organic material is prolific with microorganisms, and the microorganisms multiply exponentially when they come in contact with water, thus the water in a closed loop system is overtaken very rapidly with microorganisms creating an anaerobic environment which is undesirable for plant health. In a closed loop growing system, the proliferation of microorganisms will produce anaerobic bacteria which by definition is bacteria that breaks down organic material (decay) which will attack the roots of plants causing root rot and other diseases within the closed loop system. The reason Hydroponic and Aeroponic systems were develop is because they use no soil and no organic material was to be introduced into the system avoiding the proliferation of undesirable bacteria taking over the system.

The present invention provides an automated grow system with a barrier to prevent microorganisms from entering the reservoir, real organic soil is used.

### III. DISCLOSURE OF THE INVENTION

The main aspect of the present invention is to provide a cabinet enclosure for growing trays of plants in a soil base using LED lighting and recalculated charcoal filtered water.

Another aspect of the present invention is to use concentrated sea water extract as a nutrient.

Another aspect of the present invention is to pre-soak the seeds in a nutrient before planting.

Another aspect of the present invention is to prevent mildew by constantly circulating ambient air over the plants.

Another aspect of the present invention is to recycle the soil and roots after harvest.

Another aspect of the present invention is to use enhanced organic soil as the growth medium.

Another aspect of the present invention is to use a controller and a DC electric source to power LED lighting, water filtration including magnetic field saturation and hydration cycles.

Another aspect of the present invention is to supply an attractive cabinet for a system enclosure.

Another aspect of the present invention is to supply a potted plant embodiment.

Another aspect of the present invention is to hydrate the soil from the bottom of the hydration tray and grow containers and enhance the soil with an absorptive additive to increase the capillary watering action of the soil.

Another aspect of the present invention is to use magnetic treatment of the reservoir water.

Electromagnetic fields (EMFs) have shown great potentials in medical, industrial and environmental applications 1 7. Because of the electrical origin of the live and existence of all cells and living creatures, EMFs can interact with all living cells so that can modulate their functions. These modulations in appropriate conditions can have useful outcomes such as treatment or inducing the desire characteristics in different compounds. Water is a crucial source for life on the earth. Any living creature needs water to hydrate every cell. Long term and frequent droughts and competing water demands in most parts of the world have caused severe pressure on water resources. In addition, high costs of irrigation in the most countries are the main problem of agriculture development. Annually large quantities of water are used in agriculture. Therefore emerging of new strategies to reduce consumption of water is of significant importance. One of the new strategies is magnetic water technology. Various studies have revealed that magnetic treatment of irrigation water can improve the productivity of water. MWT has shown promising potential in saving water resources that will be of significant importance in near future. MWT has shown various potentials in environmental and agricultural applications. Some of these applications are therapeutic effects of MW, preventing scale deposition, improving irrigation water quality and crop yield, scale elimination, soil improvement, corrosion control and wastewater treatment.

### Magnetic Water Treatment in Agriculture

In normal or non-MW, the water molecule clusters comprising of many water molecules are loosely attracted. This loose and chaotic form of attraction predisposes the water to toxins and pollutants to travel inside the water molecule cluster. The large structure of these water molecule clusters or presence of toxins blocks large portions of these clusters when they pass through the cell membrane. The smaller size of these chaotic clusters, some of them carrying toxins, can enter the cell with consequent harmful effects. Therefore, to hydrate a plant a great deal of normal water is required. Magnetic treatment of water restructures the water molecules into very small clusters, each made up of six symmetrically organized molecules. This tiny and uniform cluster has hexagonal structure thus it can easily enter the passageways in plant and animal cell membranes. In addition, toxic agents cannot enter the MW structure. These features make MW a bio-friendly compound for plant and animal cells. MW can be used to increase crop yield, induce seed germination and benefit the health of livestock. Studies have demonstrated that MW for irrigation can improve water productivity; thus, conserving water supplies for the expected future global water scarcity. In addition, MW is reportedly effective at preventing and removing scale deposits in pipes and water containing structures.

### Magnetic Treatment of Irrigation Water

Previous studies have shown several beneficial effects of MF treatment on the growth of plants. It was demonstrated that an optimal external EMF can increase the rate of the plant growth, especially the percentage of seed germination Podleoeny et al. (2004) reported that exposing the broad bean seeds to variable magnetic strengths during before sowing imposes significant effects on seed germination and seed yield. In addition, they showed that applying MF to broad bean during the growing season can increase the number of pods per plant and reduce the plant losses per unit area. Several studies have demonstrated the effectiveness of MFs on the root growth of various plants. Similarly, Muraji et al. (1992) observed that MF treatment increases the root growth of maize1. Turker et al (2007) reported that static MF has an inhibitory effect on the root dry weight of maize plants, but had a beneficial effect on root dry weight of sunflower plants. Different studies have shown the inhibitory effect of weak MF on the growth rate of primary roots during early growth. It was demonstrated that MF can decrease the proliferative activity and cell reproduction in meristem cells in plant roots.

Magnetic treated water undergoes several changes in its physical properties. It also exerts several effects on the soil-water-plant system. Leaching the soil with MW significantly increases available soil phosphorus content compared with the leaching with normal water at all soil depths. Behavior of nutrients under an MF is a function of their magnetic susceptibility.

The previous studies have shown that the effects of magnetic treatment varied with plant type and the type of irrigation water used, and there were statistically significant increases in plant yield and water productivity (kg of fresh or dry produce per kl of water used). In particular, the magnetic treatment of recycled water and 3000 ppm saline water respectively increased celery yield by 12% and 23% and water productivity by 12% and 24%. For snow peas, there were 7.8%, 5.9% and 6.0% increases in pod yield with magnetically treated potable water, recycled water and 1000 ppm saline water, respectively.

Another aspect of the present invention is to provide a simple manual watering system.

Other aspects of this invention will appear from the following description and appended claims, reference being made to the accompanying drawings forming a part of this specification wherein like reference characters designate corresponding parts in the several views.

The grow containers are hydrated from underneath for a specific set time allowing a specific volume of water to reach a specified height or water line in comparison to the amount of soil in the grow container. The bottom of the grow container is perforated in a specific way (amount of holes for the even distribution of water required to hydrate the tray) by the capillary action of the soil. In addition to the holes in the bottom of the tray a hydration barrier (2 ply unbleached paper towel) is placed in the bottom of the grow container to slow the water entering the grow container, and allowing the soil to absorb by capillary action the water that is passing through the barrier. The soil can then lift all the water (absorb it) as it passes through the barrier. The timing sequence prevents the water level to remain long enough for the soil to become oversaturated. As the water recedes from the grow container very little water leaches out of the tray (soil) and back into the reservoir. The hydration barrier also acts as a filter for any microorganisms returning with the water to the reservoir when the watering cycle ends.

The water in the reservoir is continually cycled through activated charcoal and a 100 micron filter sock to keep it clean.

As the water cycles it is continually cleaned, structured, and imploded or (magnetized) for the highest nutrient uptake when hydrating the plants in the trays. All nutrients that the plants need, all fertilizers, fungi, PH stability, minerals, microorganisms that the plants need are contained in the soil that is placed in the trays. Therefore, cultivator needs no knowledge or experience to grow healthy plants and maintain a successful growing environment.

The soil is organic, contains microorganisms and decomposing organic material and is the nutrient source for all the plant needs to grow. This method of capillary hydration allows for hydration of the organic soil without compromising the water supply that normally would go anaerobic rapidly when water comes in contact with organic material and microorganisms.

Fans can exchange the air in the cabinet up to 60 times an hour to prohibit bacteria growth on the plants or cabinet surfaces.

LED lighting is programmable for effective plant growth. Water cycles (hydration cycle) are programmable. This method of capillary hydration can be expanded to larger scale hydration trays and grow containers that could sustain an indoor organic growing system on a commercial level.

The present invention uses vertical rows of tiered hydration trays with grow containers (also called nursery trays). A typical size grow container is ten inches by ten inches, each containing soil (organic material). The grow trays are tiered within a closed loop (automatic timed) watering system that is connected to an integral reservoir. When the programed hydration cycle is triggered, water is pumped from the reservoir to the top tier hydration tray for a specified duration ending when the water reaches a specific height (water line) in the hydration tray which in turn triggers a bell siphon placed in the hydration tray. As the siphon is triggered in the top tier hydration tray all the water is removed by the action of the siphon to the hydration tray that is tiered directly below. The lower succeeding hydration tray which is positioned just below the top tiered hydration tray is then filled with the water from the top hydration tray, the identical water line is reached, and another siphon placed in the second hydration tray is then triggered and all the water in the second hydration tray is removed by the action of the siphon to the succeeding 3rd lower hydration tray. This cascading effect is repeated by progressing down all the tiered hydration trays until the last hydration tray (lowest tray) is discharged into the reservoir ending the hydration cycle for the entire enclosure. The advantage of this type of closed loop “programmable interval hydration” is that each hydration tray receives exactly the same amount of water for the same amount of time in which the completed cycles can be easily programmed.

Since the amount of water in the hydration tray can be easily and precisely controlled by time, volume and height, (water level) a ratio of water to the absorption rate of the soil in the grow containers which are placed in the hydration tray can now be established. The present invention includes a closed loop automated watering system one in which as the water comes in contact with organic material (soil) and the microorganisms in the soil only for a brief preset programmable time. The controlled amount of water that comes in contact with the soil is then lifted upward by capillary action as it is absorbed by the wicking properties of the soil.

To help control the capillary action of the soil the bottom of the grow container which holds the soil is systematically perforated with ¼″ (6.35 mm) holes to allow water to pass up through the bottom of the tray evenly as the water comes into contact with the soil. The perforations (holes) in the bottom of the grow container account for 1% of the surface area of the bottom of the grow container and are evenly distributed over the tray bottom.

In addition to the holes a 2-ply unbleached paper towel is placed in the bottom of the grow container as a barrier-filter to further slow the water from entering the grow tray and to act as a filter so the soil does not pass back through the perforations as the water recedes when the siphon is triggered.

Constant and successful soil hydration results have been achieved by using a soil depth of 20 mm per grow container and hydrating the tray to a 10 mm water depth for 2 minutes every 24 hours.

### Note:

Immediately after the grow container has been hydrated and the soil is wicking up the water that has penetrated the tray and the siphon has removed the surrounding water, the nursery tray when lifted from the hydration tray will leach as little as 5 mm of water back into the system—reservoir.

During the complete watering cycle when all three tiers of grow trays have been hydrated for 2 minutes the 9 (10×10 inch) grow containers in the 3 tiers of hydration trays will leach a total of approximatley 45 mm of water back to the reservoir every 24 hours.

The reservoir holds 10 gallons of water and the recycle pump continually circulates the 10 gallons of water, approximately 12 times an hour. The water passes through a 100-micron filter sock, a magnetic field and a series of spheres and activated carbon pellets, and is able to keep the water clean for many months before it is changed. The only water that is added to the enclosure is due to evaporation and the hydration of the tiers. Water consumption is approximately 1½ gallons a week to produce 9 10×10 inch grow containers of microgreens.

### IV. BRIEF DESCRIPTION OF THE DRAWINGS

FIG. 1 is a cross sectional view of the hydration tray and siphon and grow container assembly.

FIG. 2 is a cross sectional view of a pre-plant germination container.

FIG. 3 is a front elevation view of a cabinet style grow system with three hydration trays.

FIG. 4 is a rear perspective view of an optional air manifold embodiment.

FIG. 5 is an exploded view of a mounting arrangement for the hydration, tray levelers, bell siphon and LED lights.

FIG. 6 is a rear elevation view of the reservoir closed loop filtering system.

FIG. 7 is a flow chart of control logic.

FIG. 8 is a close up view of the siphon mounting assembly.

FIG. 9 is an exploded view of the siphon mounting assembly.

FIG. 10 is a cross sectional view of a germination container with seeds (15 grams).

FIG. 11 is a cross sectional view of the germination container with seeds and inoculated with a fungi and water.

FIG. 12 is a cross sectional view of the germination container with the water drained and a sponge type additive (preferred coconut coir), four ounces by volume.

FIG. 13 is a top perspective view of a grow container with a layer of filler barrier and a bottom layer of top soil (20 mm depth) and a top layer of the germinated seed mixture of FIG. 12 added on top.

FIG. 14 is a top perspective view (with edge cross section) of a spray on step of mineral solution (sea water such as Sea-Crop).

FIG. 15 is a top perspective view of an alternate embodiment grow basket and tubular hydration tray.

FIG. 16 is a cross sectional view of the grow basket of FIG. 15.

FIG. 17 is a cross sectional view of an experiment to calibrate the flow rate of the filter barrier.

FIG. 18 is a front elevation view of a simple manually watered enclosure.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### V. MODE(S) FOR CARRYING OUT THE INVENTION

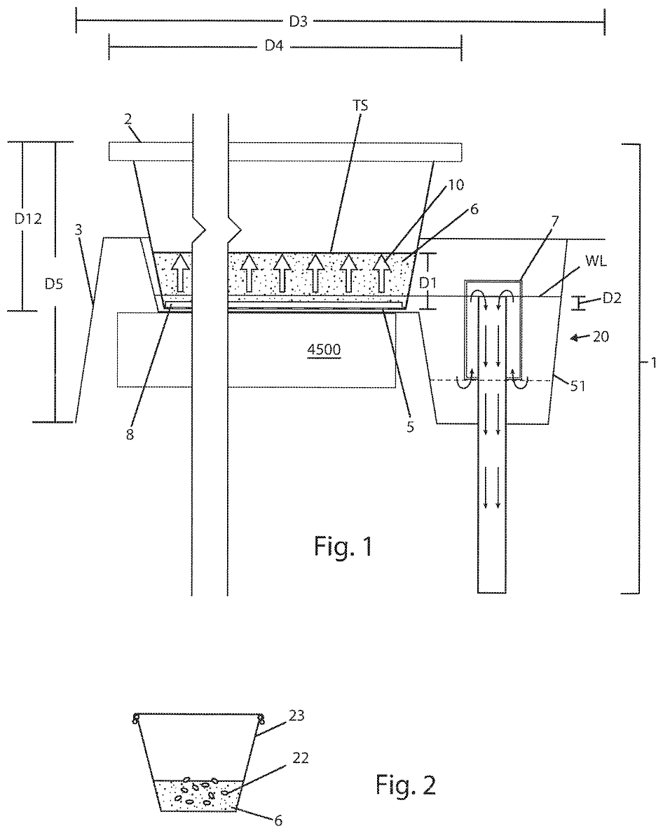

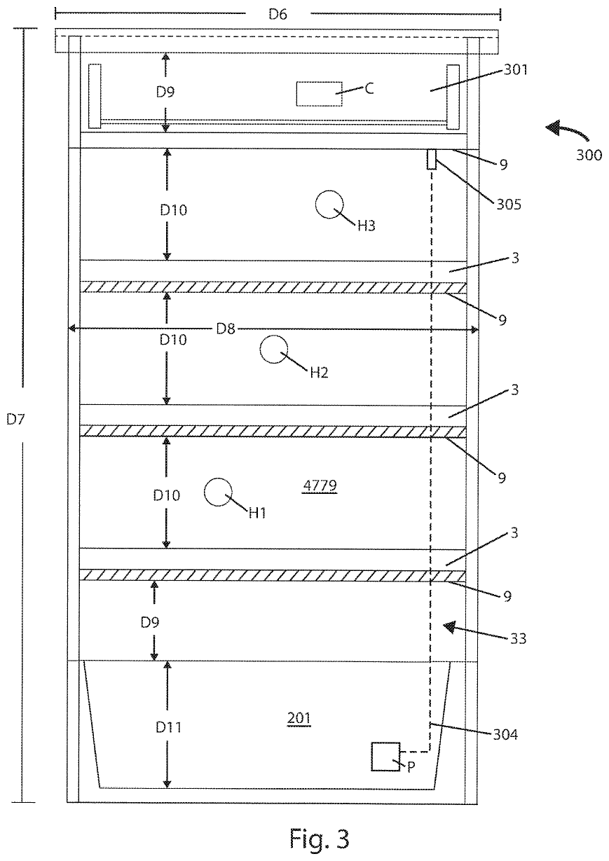

Referring first to FIG. 1 a grow subsystem 1 can be replicated in a stack of two or more layers as shown in FIG. 3, grow enclosure 300. Each subsystem 1 comprises a hydration tray 3 with an outlet 20 having a Bell Siphon 7. Each hydration tray 3 can be wide enough, such as three grow containers 2. Nominal dimensions are D1=20 mm (soil depth), D2=10 mm (maximum water depth adjusted by height of Bell Siphon 7), D3=1′ 1⅜″, D4=10″, D5=3¾″. Each hydration tray 3 has an overhead LED light 4500.

The soil is preferably enriched potting soil with microbes and a coconut choir to enhance wicking. A watering cycle such as once a day is selected. Each hydration tray receives enough water to trigger the Bell Siphon 7, and the water is returned to the reservoir 201 shown in FIG. 3.

The water rises to about half the soil 6 depth. Then the water is wicked up to the top of the soil labeled TS. Each grow container is preferably made of plastic with about sixteen holes 5 on its bottom 4. The water cascades down from the top hydration tray to the lower hydration trays as disclosed in U.S. Pat. No. 2,917,867 which is incorporated herein by reference.

Organic soil goes aerobatic if it stays fully moist continuously. Therefore, the preferred watering cycle is about two minutes every 24 hours. The paper towel (no ply Sprouts® brand or equivalent) 8 restricts most of the microbes in the soil 6 from reaching the reservoir 201. Without a microbe barrier 8, a timed hydration cycle and soil with good capillary properties—millions of microbes from the soil 6 would turn the reservoir anaerobic over time. An anaerobic reservoir would greatly hamper plant growth and create foul odors. Aquaponic systems using fish waste as a fertilizer require precise and costly anaerobic microbe controls, known as nitrification.

The present invention reservoir 201 holds about six gallons of water. It has stayed non-anaerobic for over two months of growing cycles.

The present invention does not use nutrients in the water, but uses organic nutrients in the soil 6.

In operation the hydration tray 3 fills up to just above the top of the Bell Siphon 7 in about two minutes. The Bell Siphon 7 starts its trigger level in about 90 seconds. By the time the cascading watering process is complete, only a few millimeters of water that has cone info contact with the soil in the grow container returns to the reservoir 201.

Referring next to FIG. 2 preferably the seeds 22 are placed in a germination container 23 with enriched with Mycorrhizal fungi which is added to a small amount of reservoir water. An overnight soaking is preferred.

Mycorrhizal Fungi 25 in FIG. 11 (Glomus intraradices, Glomus mosseae, Glamus aggregatum, Glomus etunicatum) are added to the seed at an average of (1.5 mm to 15 grams of seed) to ensure that every seed is inoculated during the hydration and germination process with the mycorrhizal spores. Seeds 22 turn into inoculated seeds 26 in FIGS. 11-14.

### Note:

Mycorrhizal Fungi build symbiotic relationships that form between the fungi and plants. The fungi colonize the root system of a host plant, providing increased water and nutrient absorption capabilities while the plant provides the fungus with carbohydrates formed from photosynthesis.

The seed and Mycorrhizal Fungi are hydrated with magnetized water W from the reservoir 201 for 12 to 14 hours depending on seed variety. During this time the seed will increase in weight and size by 50%-60% from absorbing the water and the mycorrhizal fungi will have penetrate the hull of the seed and inoculate every seed. Adding mycorrhizal to soil alone will result in few seeds actually being inoculated because the seed must come into direct contact with the mycorrhizal spores for the spores to inoculate to seed.

### Note:

The water in the reservoir is continuously cycled through two sets of magnets with the first set of magnets with repelling north poles forced together and a second set of magnets with the repelling south poles forced together to produce magnetized water in the reservoir. Reservoir water is used to hydrate the seeds (FIG. 2).

This planting method relates to a process that enhances the ability of the seed to germinate, absorb vital nutrients and flourish in a controlled environment to produce nutrient dense food in that controlled environment. All aspects of the growing process in which plants thrive have been considered and applied in a specific way so plants (microgreens) can produce a highly nutrient dense crop in an automatic and consistent fashion.

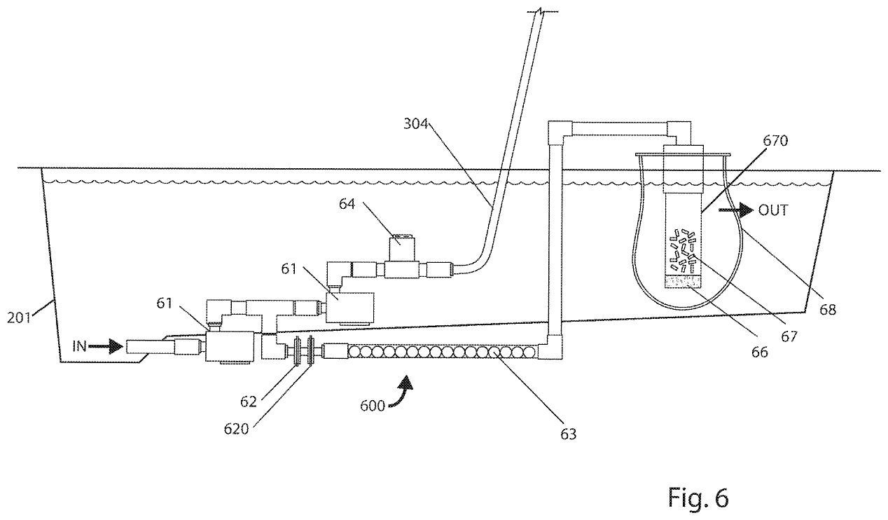

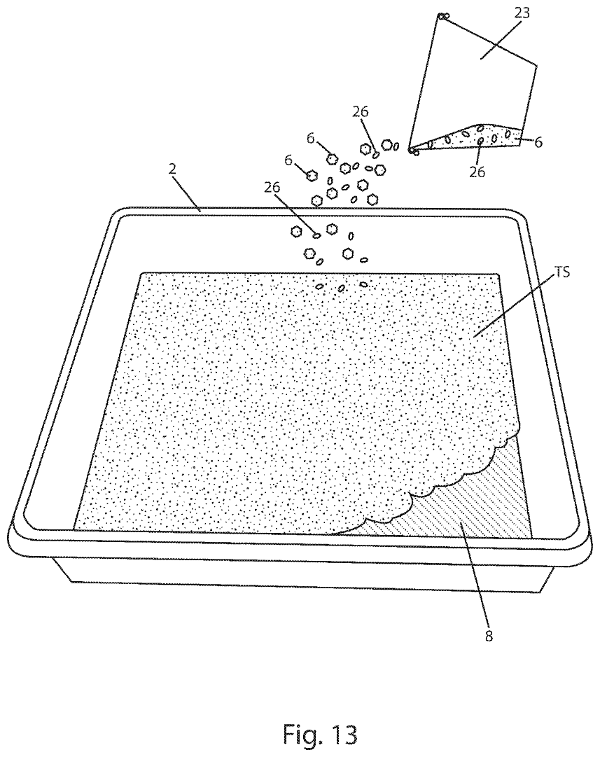

Magnetized water can raise germination rates 12%-13% and crop yields as much as 12%. The water in the reservoir also continuously passes through a series of spheres to gain structuring properties. Structured water is high in oxygen content which is essential to plant life. Moreover, watering using structured water provides better hydration to the plants since structured water better infiltrates the root system of plants, letting them absorb as many nutrients as they may need for growing. See FIG. 6. After the overnight soaking period, the water is drained from the seed. The seed is mixed with Coco Coir 60. See FIG. 12. The absorption barrier 8 is placed in tray 2. See FIG. 13. The soil is custom formulated for a stable PH level of 6.4, its wicking properties, ability to move water upward against gravity (capillarity, capillary motion) with high nutrient content fungi and microorganisms.

### Ingredients:

### OMRI Listed Coco Coir, OMRI Listed Perlite, Azomite, Calphos, Glacial Rock Dust, Kelp Meal, Oyster Shell, Dolomite Lime, Earthworm Castings, 100% Plant-based Compost, and Mycorrhizae.

The seed mixed with Coco Coir is placed in the tray 2 and hydrate with ionic mineral solution, 60 mm per tray, then place tray in growing unit 1 of FIG. 1. (ionic minerals are water soluble and ready to be used by the plants). The Coco Coir will absorb the mineral solution and hold it near the seeds being readily available to the seeds as the seeds germinate. It will not wash away from the seeds because the soil in the grow containers are hydrated from underneath and the water is pulled upward by the soils (capillary action) thus the minerals will be available for the seedlings for the entire growing cycle. No other fertilization is necessary. With the enhancements made to the water and soil, every seed has the optimal ingredients available in an organic form to grow a healthy nutrient dense crop, without any previous experience by the cultivator.

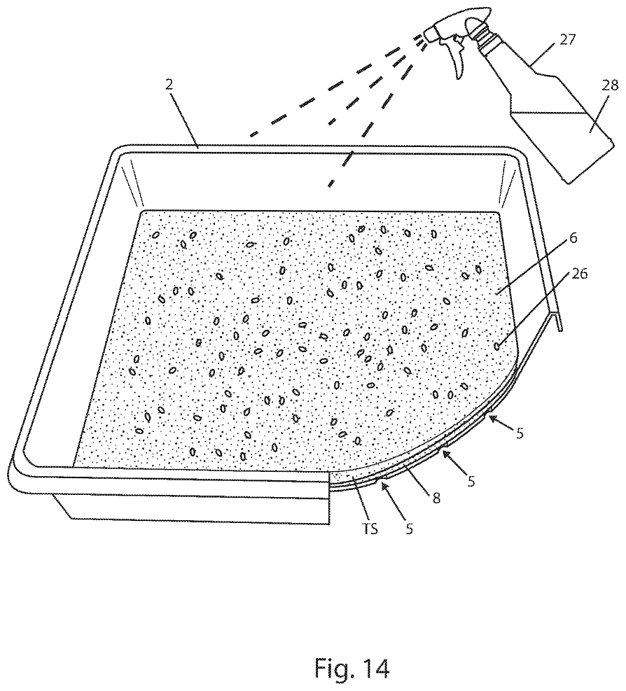

A mineral solution (Sea-Crop® Concentrate or equivalent) is sprayed over the soil 6 once. This mineral solution spray is a soil microflora stimulant containing over 90 natural source trace minerals and active organic substances from Pacific Ocean Water (certified Organic by Washington State). See FIG. 14 with the mineral solution 28 in sprayer 27. The top soil TS has a wicking agent such as Coco Coir, peat moss.

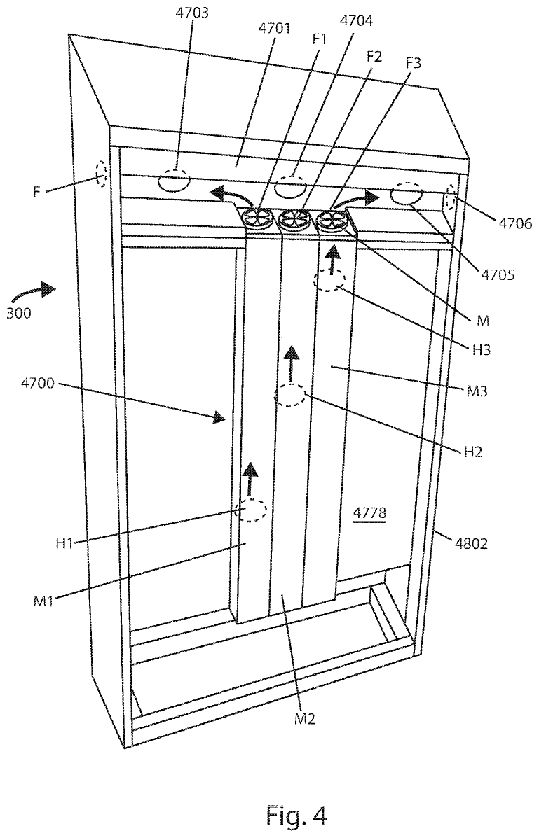

Referring next to FIG. 3 a cabinet style grow enclosure 300 has nominal dimensions of D6=2′ 3⅞″, D7=48½, D8=37¾″, D9=5″, D10=7″, D11=8″, (D12=2.25″ (FIG. 1 height of grow tray 2)). Three grow trays 3 are supported in the enclosure 300. A top drawer 301 houses the electronic controls. An opening 33 provides access to the reservoir 201 for filling and maintenance. The fans (F1, F2, F3 FIG. 4) run continuously to prevent excess bacteria growth on the plants and cabinet (enclosure) surfaces. The LED lighting can be a 12 V DC strip of various colors such as made by too god tm and LE Lighting Ever™, made in China. It is known in the art to select combinations of red, blue, and white frequency ideal for each plant. Nominally the controller C will cycle 14 hour days and 10 hour nights.

The pump P sends water up pipe 304 to outlet 305 above the top hydration tray 3. Cascading occurs as described above in FIG. 1.

Referring next to FIG. 4 a grow cabinet 300 has a rear manifold assembly 4700. Manifold M1 has entry port HI and exhaust fan F1 into exhaust manifold 4701 and out ports 4702, 4703, 4704,4705, 4706. Manifold M2 has fan F2, entry port H1, and exhausts into common exhaust manifold 4701. Manifold M3 has fan F3 entry port H3, and exhausts into common exhaust manifold 4701. Back panels 4777, 4778 seal the back of system 300 and have a front reflective surface 4779 for light propagation, see FIG. 3.

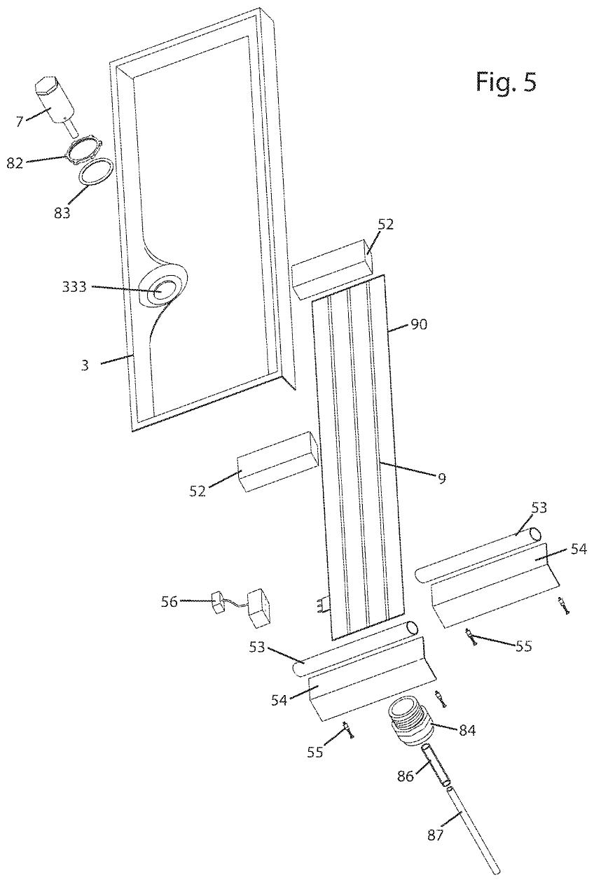

Referring next to FIG. 5 the hydration tray 3 of FIG. 1 is shown in a preferred exploded embodiment. L brackets 54 connect to the sides 4801, 4802 of the cabinet 300. PVC pipes 53 can be leveled by adjusting bolts 55. Pipes 53 support the grow tray 3. Blocks 52 could be glued under opposite edges of the grow tray 3. LED panel 90 has LED straps 9. The panel 90 is fastened to the blocks 52. The rear of panel 90 has a male connector 91 that fits into female connector 92 on the rear of cabinet 300 power hub 56 powers the female connector 92. The drain hole 333 receives the syphon collar 84 which supports the drain tubes 86, 87.

Referring next to FIG. 6 the reservoir 201 contains a closed loop water conditioning system 600. Arrows IN and OUT show a closed loop water conditioning flow route. A (12 V DC) pump 61 is usually run continuously. Solenoid valve 64 is closed except during the hydration cycle. For the hydration cycle valve 64 is opened to pump water via pump 61 up the tube 304. See drawing FIG. 6. The closed loop filtering system takes the water through pair of repelling north 62 and repelling magnets south 620. Next a tube full of (0.625 inch) glass spheres 63 causes turbulence called structured water. Next a filter 670 has activated carbon pellets 67. Next a foam screen 66 passes the water to filter sock 68. In use this water stays fresh for months.

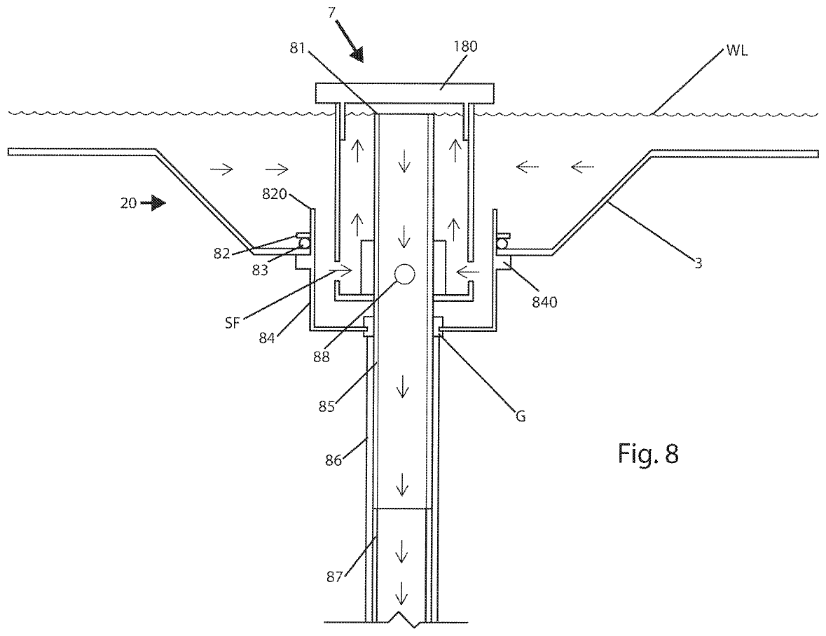

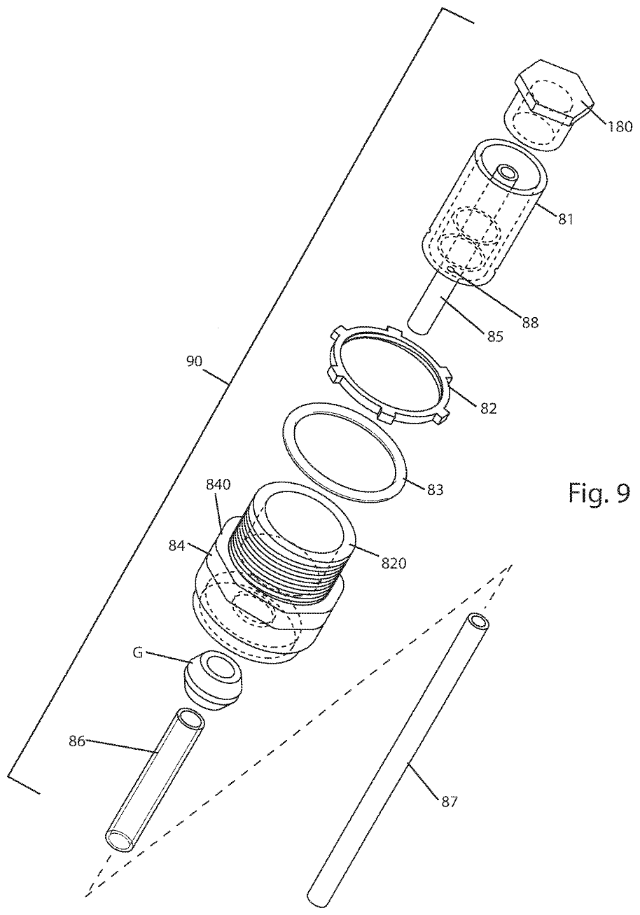

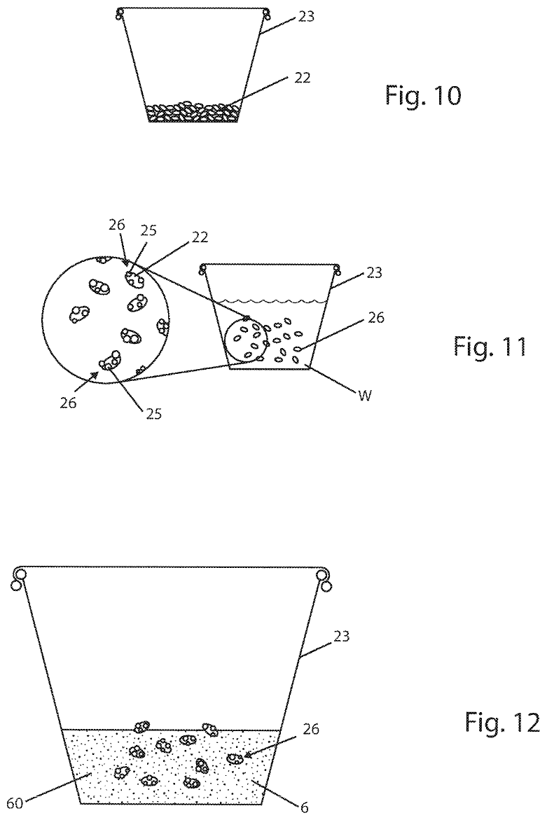

Referring next to FIGS. 8, 9 the hydration tray 3 of FIG. 1 has outlet 20. A syphon collar 84 has an upper threaded cylindrical flange 820 with a nut 82 and washer 83 locking the collar 84 in place with ledge 840 compressed against the tray 3. The bottom 85 of the syphon 7 can be adjusted to a desired height along rubber gasket G. The water level WL height is controlled by the placement of the bottom 85. In a known manner as the water fills to the top 81 of the syphon 7 it falls down the bottom 85 and creates a syphon force SF which drains the tray 3 dry. The top 180 is removable. Stem 88 is a hole.

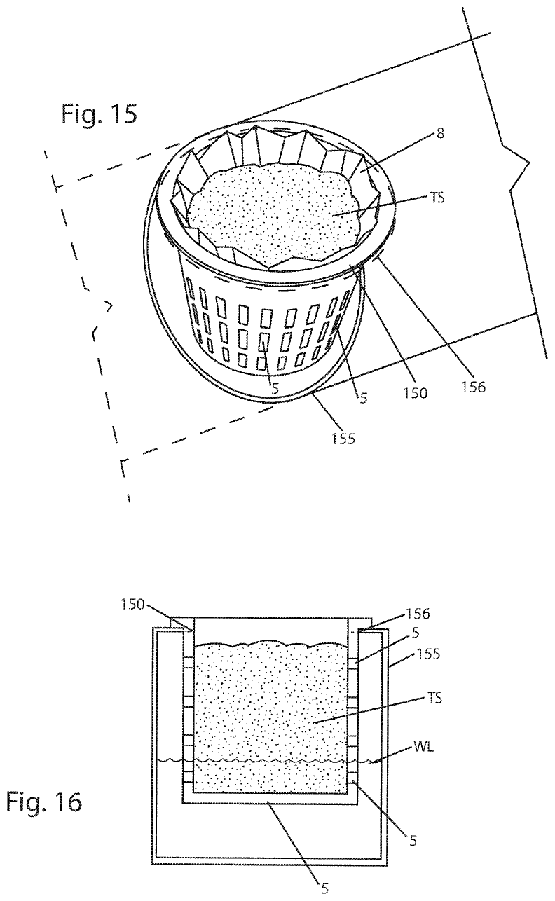

Referring next to FIGS. 15, 16 an alternate grow tray can be a pot 150. This pot 150 could be any shape such as round or square. A hydration tray 155, a PVC pipe would have holes 156 to receive the grow pot 150. The hydration tray 155 could be any shape such as round or square.

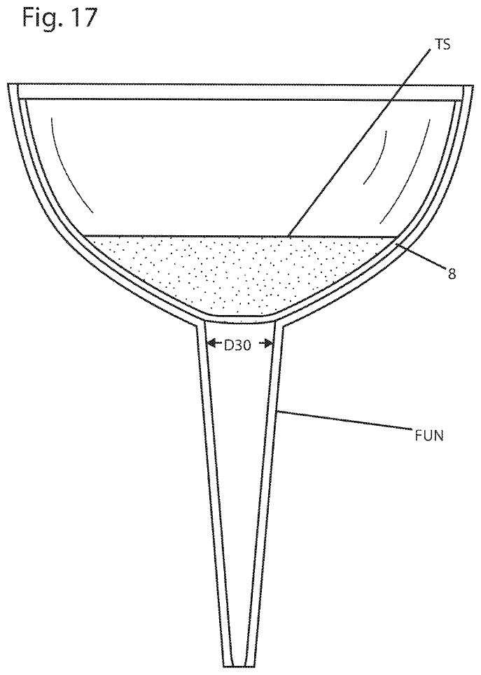

Referring next to FIG. 17 the barrier 8 is calibrated in a funnel FUN. About 20 mm of the top soil TS is placed on top of barrier 8 (paper is preferred). The diameter D30 is chosen to provide an exit port of the same area as all the holes 5 in FIG. 1. The barrier porosity is calibrated to let all the water escape in about five and a half minute S.

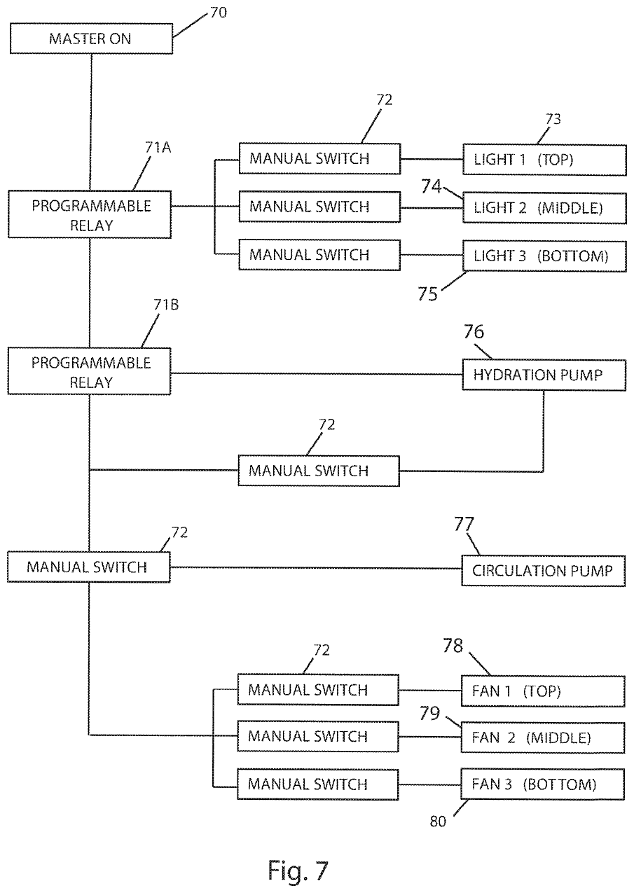

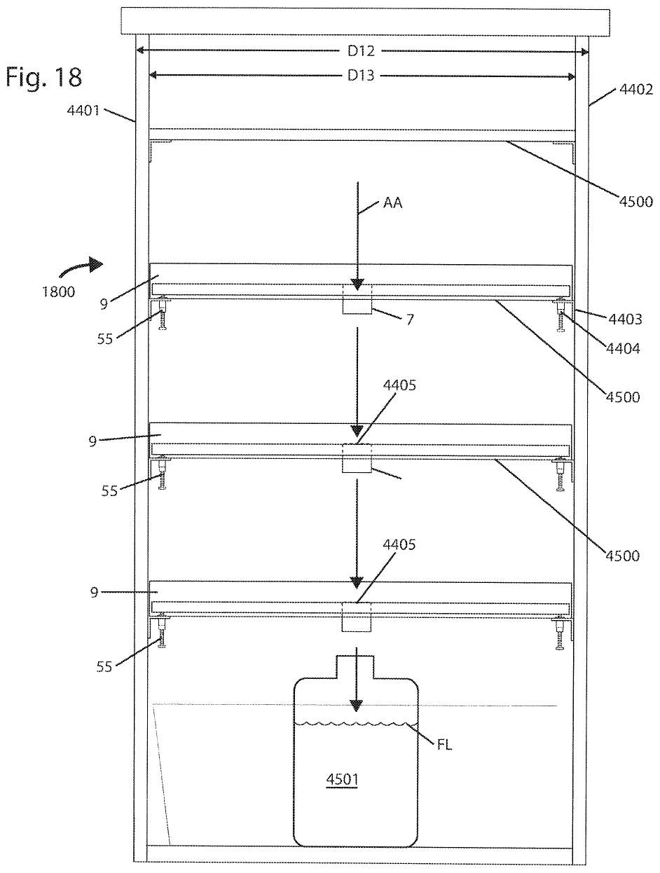

Referring next to FIG. 18 a low cost grow stand 1800 can be made with sides 4401, 4402 made of plywood or rigid shelving style plastic coated wires. Three hydration trays 9 are supported across the sides 4401, 4402 in any known manner such as L brackets 4403 with leveling bolts 4404. Each hydration tray has a central drain 4405 for a Bell Siphon 7 functioning as shown in FIG. 1 above each grow tray is a light 4500 (LED). The lights 4500 could be manually switched or programmed as shown in FIG. 7. The siphons 7 are axially aligned along axis AA with water bottle 4501.

In operation each hydration tray 9 has about three grow containers 2 as shown in FIG. 1. The water bottle 4501 can be filled with tap water to the fill line FL. Once a day the cultivator takes the bottle 4501 and pours it into top hydration tray 9. Due to the slow release of the filter barrier 8 and the holes 5 (FIG. 1), the water stays in the tray long enough to reach about half way up soil level, then wicking draws the water to the surface of the soil in the grow tray. The excess water cascades down to the tray below.

The bottle 4501 is placed below the lowest Bell Siphon 7 as shown, and all water not absorbed by the various grow containers returns to the bottle 4501. The cultivator fills the bottle 4501 to the fill level FL and repeats the watering process daily or as often as needed.

No fans are used. This simple grow stand uses the non-obvious soil and filter barrier hydration cycle disclosed above.

Referring next to FIG. 7 the basic flow logic of the FIG. 3 embodiment is shown.

A master power switch 70 controls a DC voltage (preferred) to all electronic components. A programmable relay 41 A sends power to lights 1, 2, 3 (item 73) through manual switches 72. This allows the grower to shut off one tray lighting for non-use or special plant considerations.

A programmable relay 71B could be set at a once a day two minute pump cycle for pump 76. A manual switch 72 would start an extra cycle whenever desired without altering the cycle set in programmable relay 71B. A manual switch 72 controls the continuously running circulation pump 77 for the reservoir 201 shown in FIG. 3 Fans 1, 2, 3 (items 78, 79, 80) are switched ON/OFF by manual switchers 72. They normally run continuously.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

1. An apparatus, comprising:
a grow container having a grow container side wall joined to a grow container bottom having a plurality of aperture elements open between an internal surface and an external surface of said grow container bottom; and
a hydration barrier disposed over said internal surface of said grow container bottom.

2. The apparatus of claim 1, wherein said hydration barrier comprises a filter barrier.

3-7. (canceled)

8. The apparatus of claim 1, further comprising a hydration container having a hydration container side wall joined to a hydration container bottom defining an internal surface and an external surface, said internal surface defining an interior space configured to receive said grow container, said hydration container including at least one aperture element open between said internal surface and an external surface of said hydration container.

9. The apparatus of claim 8, further comprising a hydration liquid recycling system having a pump operable to deliver a hydration liquid from a hydration liquid source to said hydration container and return said hydration liquid passing through said at least one aperture in said hydration container to said liquid source.

10-13. (canceled)

14. The apparatus of claim 9, further comprising one or more filter elements removably coupled to said liquid recycling system, wherein said one or more filters filter said hydration liquid recirculated in said liquid recycling system, wherein said one or more filter elements comprises a filter sock having a porosity of about 100 micrometers.

15. (canceled)

16. The apparatus of claim 14, wherein said one or more filter elements comprises activated carbon pellets.

17. The apparatus of claim 9, further comprising one or more pairs of magnets, each of said one or more pairs of magnets disposed in oppositional, like polarity relation, wherein said hydration liquid passes between said one or more pairs of magnets.

18. The apparatus of claim 17, further comprising a series of spheres, wherein said hydration liquid passes about said series of spheres.

19. The apparatus of claim 9, wherein said hydration container comprises a plurality of hydration containers, said plurality of hydration containers arranged vertically between a top hydration container and a bottom hydration container, wherein said hydration liquid recycling system delivers hydration liquid to said top hydration container, and returns said hydration liquid passing through said aperture element of said bottom hydration container to said hydration liquid source.

20. (canceled)

21. The apparatus of claim 1, further comprising a soil layer disposed in said grow container.

22. (canceled)

23. The apparatus of claim 21, further comprising a plurality of seeds disposed on top of said soil layer.

24. The apparatus of claim 23, further comprising a mineral layer disposed on top of said plurality of seeds and said soil layer.

25. The apparatus of claim 24, wherein said plurality of seeds soak in a germination container containing Mycorrhizal fungi admixed with said hydration liquid prior to being disposed on said soil layer.

26. The apparatus of claim 21, wherein said soil layer has a depth X.

27. The apparatus of claim 26, wherein said hydration liquid recycling system delivers said hydration liquid to said hydration container to to a height of about one half of said depth X of said soil layer.

28-29. (canceled)

30. The apparatus of claim 27, wherein said soil layer wicks said hydration liquid through said plurality of aperture elements of said grow container to said plurality of seeds.

31. The apparatus of claim 30, wherein said liquid recycling system drains said liquid from said hydration container at said height of about one half of said depth X of said soil layer to maintain said mineral layer on top of said plurality of seeds and said soil layer.

32. (canceled)

33. The apparatus of claim 1, wherein porosity of said hydration barrier precludes passage of soil layer constituents or mineral layer constituents through said hydration barrier.

34. The apparatus of claim 1, wherein porosity of said hydration barrier filters microorganisms from liquid passing through said hydration barrier.

35. (canceled)

36. The apparatus of claim 19, further comprising:
an enclosure having an enclosure side wall joining an enclosure top and an enclosure bottom defining an enclosure interior space adapted to receive said plurality of hydration containers:
one or more fans coupled to said enclosure; and
one or more light emitting elements coupled to said enclosure.

37-39. (canceled)

40. The apparatus of claim 36, further comprising a controller including a processor communicatively coupled to a non-transitory memory element, said memory element containing a controller program, said controller electronically coupled to one or more of: said pump, said one or more fans, and said one or more light emitting elements.

41. The apparatus of claim 40, wherein said program executable to activate said pump, said one or more fans, said one or more light emitting elements to operate during a pre-selected time duration or during pre-selected cyclic time durations.

42-138. (canceled)
